(19) United States
(12) Patent Application Publication
(10) Pub. No.: US 2007/0008938 A1
(43) Pub. Date: Jan. 11, 2007

(54) Virtual network system

(75) Inventors: Eduardo Nebot, Sydney (AU); Jose Emilio Guivant, Sydney (AU)

Correspondence Address: MILLER, MATTHIAS & HULL, ONE NORTH FRANKLIN STREET, SUITE 2350, CHICAGO, IL, 60606, US

(73) Assignee: CMTE Development Limited, Pinjarra Hills (AU)

(21) Appl. No.: 10/573,104

(22) PCT Filed: Sep. 27, 2004
(86) PCT No.: PCT/AU04/01328

§ 371 Date: Mar. 23, 2006

(30) Foreign Application Priority Data
Sep. 26, 2003 (AU) 2003905293

(51) Int. Cl. H04Q 7/24

(52) U.S. Cl. 370/338

(57) ABSTRACT

A virtual wireless computer network allows communication between a number of regions (F, G, H), which may be beyond normal wireless communication range, by carrying information between regions using mobile stations (5) which travel between regions. Each mobile station transmits and/or receives information by wireless communication to other stations within a region when it is in that region, to update both the stations in that region and the mobile station. One region may include a fixed station (8) hardwired into a backbone network (9). The network has particular application in a mining situation where the mobile stations may be haul trucks (5) carrying information between people 6 and light vehicles (7), with the fixed station at a crusher or shovel (8).

### FIELD OF THE INVENTION

This invention relates to a virtual wireless computer network and has been devised particularly though not solely for use in a mining situation.

### BACKGROUND OF THE INVENTION

With the use of wireless computer technologies becoming more common, with accessible off-the-shelf systems now available in the market place, it has become known to create ad-hoc temporary dynamic networks. Under the IEEE's proposed standard for wireless LANs (referred to throughout this specification as IEEE802.11x, being any of the IEEE802.11 wireless networks), there are two different network configurations: ad-hoc and infrastructure. In the ad-hoc network, computers are brought together to form a network in real time. FIG. 1 shows the structure of this network where each element is potentially in contact with any other element within the range in the network. Such virtual networks, when combined with fixed stations connected to a hard wired backbone can be used to monitor or share information between different databases.

There are some situations however where individual ad-hoc networks may not be in wireless range of one another and where it is impractical to provide a wireless link or a hard wired backbone between the various ad-hoc networks. Such situations commonly exist in mining environments where various groups of equipment are spaced apart a considerable distance from one another or where their relationship changes as the mining operation develops, in an environment where it is inconvenient or difficult to provide hard wired connections.

### SUMMARY OF THE INVENTION

Accordingly, the present invention provides a virtual wireless computer network including a plurality of stations arranged to interface with each other by wireless communication in two or more regions, at least one of said regions being beyond normal wireless communication range of other said regions, and wherein at least one station is a mobile station able to travel between regions, said mobile station being adapted to receive and/or transmit information by wireless communication in one region when in that region, and receive and/or transmit information to other regions when in those regions.

Preferably one or more of the mobile stations is located in a vehicle.

Preferably one or more of the mobile stations is located on a person able to travel between regions.

Preferably at least one of the stations is hard wire connected to a backbone system.

Preferably the stations include slow moving stations primarily adapted to be operating within regions, and fast moving stations primarily intended to be moving between regions.

Preferably network is also adapted to be used as a safety alert system providing advice to the operator of a station of the presence of other stations that may be in the immediate proximity.

### BRIEF DESCRIPTION OF THE DRAWINGS

Notwithstanding any other forms that may fall within its scope one preferred form of the invention will now be described by way of example only with reference to the accompanying drawings in which:

FIG. 1 is a schematic view of a typical prior art ad-hoc network;

FIG. 2 is a diagrammatic view of a decentralised network interaction according to the invention;

FIG. 3 is a diagrammatic view of a virtual wireless network according to the invention in use in a typical mining operation;

FIG. 4 is a schematic view of an ad-hoc network according to the invention used for detecting the proximity of other mobile stations to a truck;

FIG. 5 is a diagrammatic illustration of a typical computer box within a mobile station such as a truck;

FIG. 6 is a view of a typical operator interface panel located within a mining truck using information from the network according to the invention; and

FIG. 7 is a schematic view of a moving haul truck showing intruders approaching the front of the truck;

FIG. 8 is a schematic view of a moving haul truck showing stationery intruders in front of the truck;

FIG. 9 is a schematic view of a moving haul truck showing intruders in front of the truck and moving away from the truck;

FIG. 10 is a schematic view of a moving haul truck showing moving intruders approaching the rear of the truck; and

FIG. 11 is a schematic view of a moving haul truck approaching intruders moving in a direction perpendicular to the movement of the truck.

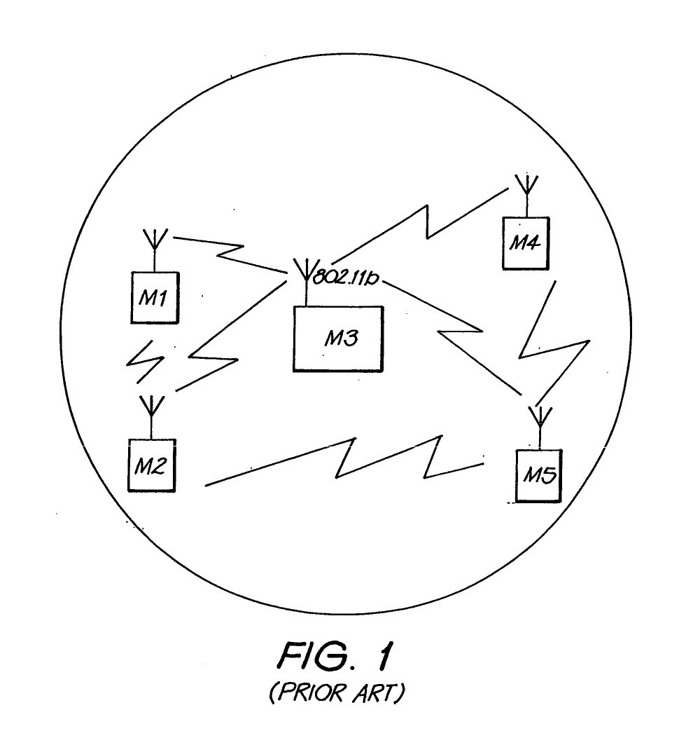

### DETAILED DESCRIPTION OF PREFERRED EMBODIMENTS OF THE INVENTION

It will be appreciated that although the virtual wireless computer network according to the invention has been devised particularly for use in a mining situation, it has broader uses and will firstly be described in terms of a general decentralised virtual network.

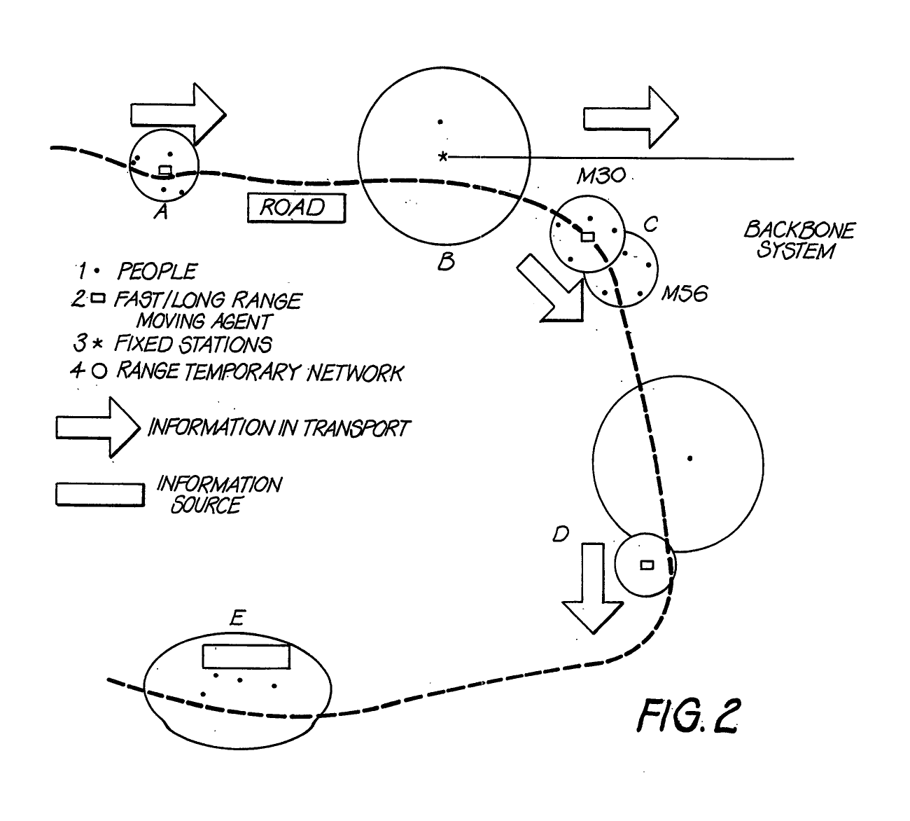

The system is designed around independent stations or agents consisting of different types and with diverse capabilities in terms of processing, tasks and functionality. Different types of agents form various ad-hoc networks that can be used to move information around areas much larger than the wireless range. FIG. 2 presents some of the functionalities of the virtual network according to the invention. In this example we have three types of agents: people 1 (slow moving local agents), fast/long range moving agents 2 and fixed agents 3. The road or common areas where the fast agents move are also shown in long chain outline. In region or zone A an ad-hoc network 4 is formed with four slow moving agents and a fast moving transport agent. This gives the capability of propagating information from slow agents through the fast moving transport agent to other areas. This information can then be collected by a fixed agent connected to the backbone system in zone B, and transferred anywhere in the world almost in real-time. Zone C presents an ad-hoc network where not all the agents are in direct contact. Nevertheless with this approach agent M56 can have the information of agent M30 by using the other slow moving agents in between. The decentralized software enables the propagation of information to all the agents in the ad-hoc network. Region D presents the case of a fast moving agent moving information to a different destination. Finally zone E presents a local area with slow moving agents interacting with information ready to transfer to other regions.

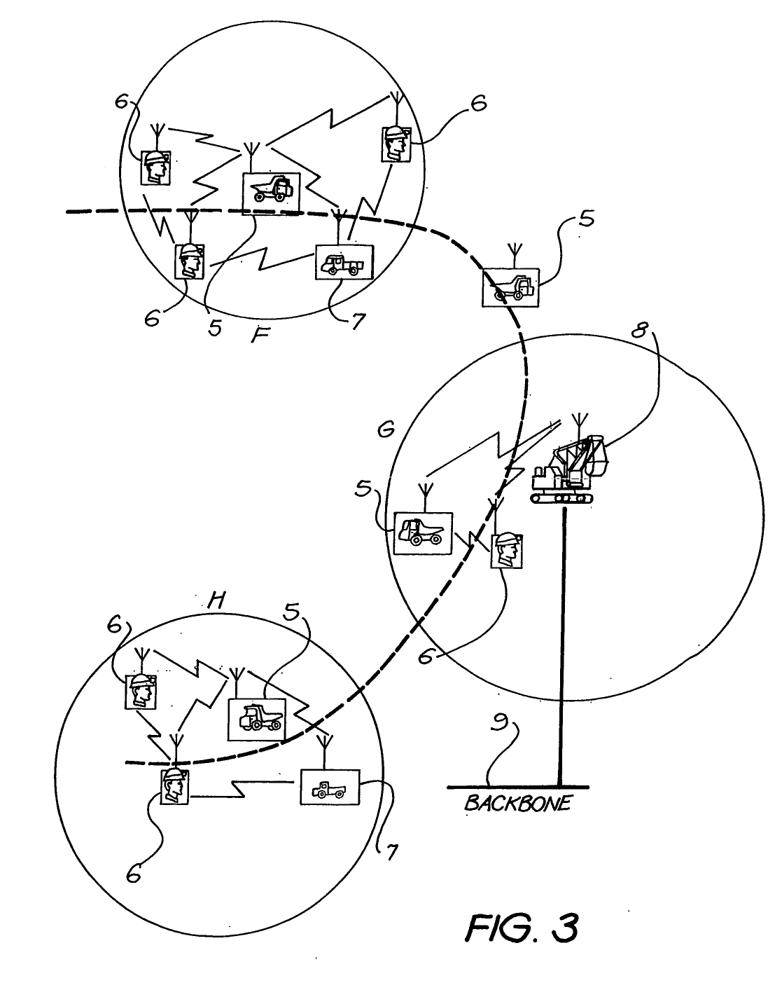

In a specific application of the invention FIG. 3 shows the typical interaction of trucks 5, people 6, maintenance vehicles 7 and shovel 8 in a mining environment. In this case each operator 6 has a PDA type device equipped with 802.11b capabilities and some can be retrofitted with GPSs or other sensory information. The maintenance vehicle 7 will have similar capabilities but different processing and storage media.

The virtual network concept introduced before can be used to transport information around the mine. In FIG. 3 an agent in the ad-hoc network F can transfer information to an agent truck 5 that is known to go to area G where a fixed station Shovel 8 is available with connection to the backbone network 9. The truck in G can also collect information with mine management directives from the backbone 9 to be delivered to other agents in area H. With this concept a very efficient virtual network can be built that connects all the operational areas of the mine without having to have full wireless coverage of all the mine area. This is efficient since the mine will always concentrate the resources in particular areas and these resources will be the ones that move with the network. The area without add-hoc networks will not require attention (coverage) and will be traversed by the normal fast moving agents, such as trucks 5.

Typically each agent will register itself in a ad-hoc 802.11x wireless network and will send a registering message reporting its own capabilities, basic information and special requests. The possible agents and some capabilities are shown in table 1

TABLE 1
Typical properties for an agent in a mining application

| Type | Static/Mobile | Position | Range | Other |
|---|---|---|---|---|
| Person 1 (P1) | M | P | | Data |
| Person 2 (P2) | M | | R | |
| Vehicle (V1) | M | P | R | Data |
| Vehicle (V2) | M | P | | Data |
| Fixed Station | F | P | R | Data |
| Fixed Station | F | | | |

The type of agents to interact in the environment are application dependant. For the case of a mining application we can define the following agents

| ID | Type | Message type | Information | Destinations |
|---|---|---|---|---|
| 10.0.1.1 | 0 Base station | Data | Data | Places |
| 10.0.1.30 | 1 Truck | Position | Data | 1, 4, 5 |
| 10.0.1.100 | 2 Person | Position | Data | 1 |

A full protocol is implemented to ensure that the information is moved smoothly through the virtual network with integrity and at the same time without saturating the network in a local area. This protocol is implemented on top of TCP/UDP libraries running in windows OS, QNX Neutrino and Power PC for PDAs

The network can also be used to provide a “Truck Safety Alert System”.

The objective of this system is to safely manage the interaction between a truck and other objects in its environment (people, utility vehicles, etc) using the capabilities of the ad-hoc wireless network. The “Truck Safety Alert System” utilises a subset of the capabilities of the overall system and provides a basic demonstration of its decentralized data transfer capabilities for a safety application.

A truck will know the position of each object in its safety zone by direct communication with that object or through retransmission from a neighbour agent. If GPS is not available the system will report the presence of that agent in the area of operation. This significantly increases the reliability of detection. Finally a two-way operation protocol can be implemented where when the truck is about to move it interrogates the agents in its safety zone.

A truck safety alert system of this type is necessary as drivers of large off-road haul trucks often cannot see objects (personnel, utility vehicles, etc) in close proximity to the truck. The zone directly in front of the truck and the zone adjacent to the non-driver side of the truck currently pose the greatest risk for an accident. These blind zones have been the cause of several haul truck/utility vehicle accidents and near misses. Of particular concern is the ability of truck drivers to verify that these zones are clear before pulling away from a stationary position.

Several technologies have been proposed in the past to solve this problem, including:

GPS based systems—these require all mobile equipment and personnel to possess a GPS unit that communicates with a base station. This solution is expensive, is not failsafe since it relies on each object having an operational GPS unit, and complete GPS coverage in the pit (not always possible).

RF ID tags—again this requires all mobile equipment and personnel to wear a RF ID tag that will respond when in the truck proximity zone. There is at least one commercial system based on this approach but it only provides indication that something is in the area. The detection of the location of the object using this technology requires additional hardware and accuracy and cost may be an issue.

Video systems—this requires computer based image recognition of an object in the proximity zone (which can be unreliable in varying light conditions). Alternatively, this approach requires the driver to see the intrusive object in a small cab-mounted video screen that in poor lighting conditions can be un-reliable.

Radar/camera system, typically an operator aid system based on a Preco radar. The radar frequency is 5.8 GHz and can detect an object at ranges up to 8 meters within an arc of 55 degree horizontal and 20 degrees vertical. It is provided with hardware that interfaces the radar and provides visual and audio alarm if an object is within the area. This output is then used to turn on the appropriate camera. Operators have not been happy with this system due to the number of false alarms provided by the system

The present invention is able to provide a reliable system that informs the driver of the presence of an unsafe condition in the area close to the truck while not providing excessive number of false alarm. A reliable solution to this problem requires the use of multiple information sources and an appropriate inference engine to report to the operator the state of unsafe objects in the area surrounding the truck.

The design uses a minimum number of sensors but still provides the basic structure in order to augment the system to achieve high reliability and the possibility to incorporate other safety and productivity enhancements.

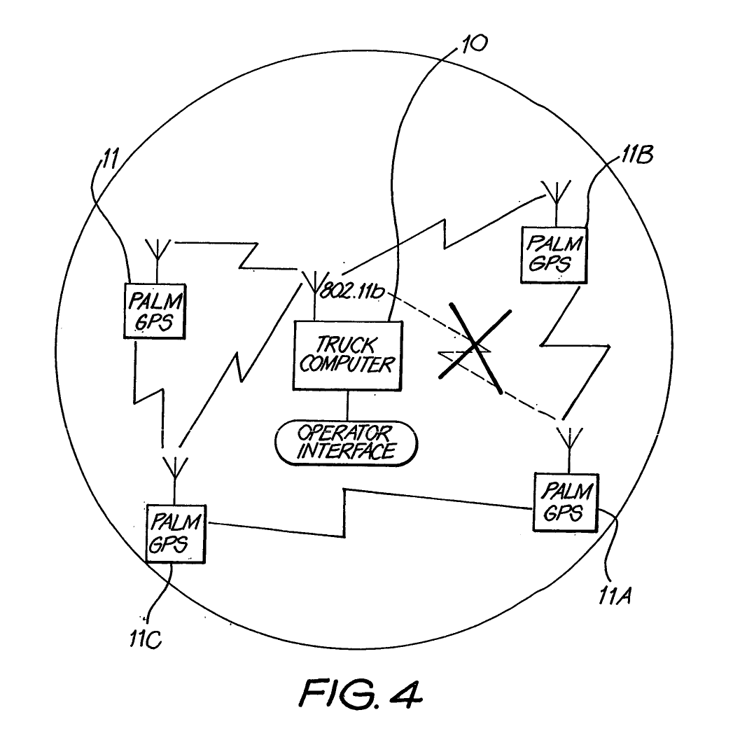

The system is based on a computer box installed in each truck (truck computer) and all mine personnel and other mobile equipment carrying PDAs retrofitted with GPS, both with wireless capabilities (IEEE 802.11x). FIG. 4 shows a temporary ad-hoc network formed by the truck 10 and mobile devices 11. It can clearly be seen that although one of the mobile devices 11A is not in direct contact with the truck, it is still aware of its location through the neighbour information from 11B or 11C. This is one clear case where the network concept helps to make the system more reliable.

Each truck CPU Box has basic computer capabilities and an IEEE 802.11x wireless network interface to interface with the targets and serial interfaces and digital/analog I/O for future expansion to different sensing and monitoring capabilities. The basic box capabilities are shown in FIG. 5.

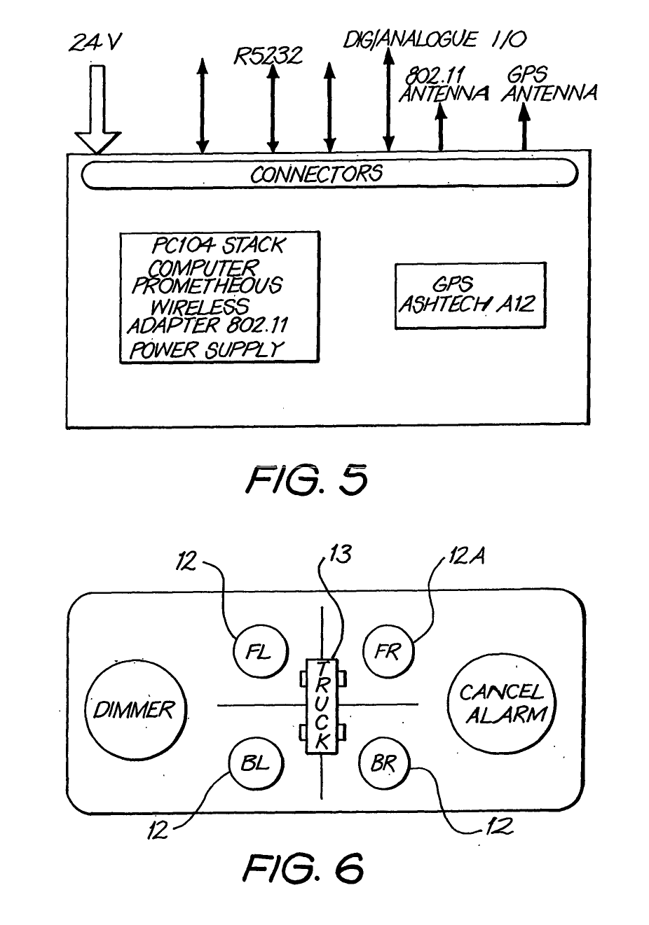

The Truck CPU is connected to an operator interface which reports to the operator that there is a potential object in the area surrounding the truck. If GPS is available and reported by the target an appropriate LED 12 will be turn on to indicate the quadrant where the object is located. For example, LED 12A will illuminate when the object is in the quadrant to the front right (FR) of the truck as presented at 13. A sounder to generate an audible alarm can also be installed in this box. Intelligent sensors with elementary bluetooth communication capabilities could be added to improve the integrity of the system. Thus, If GPS is not available or if the mobile devices are not equipped with GPS, the system would still know what object (person, truck, etc) is in its “zone” but not its exact location. The operator box is shown in FIG. 6.

The equipment that is typically carried by slow moving stations or agents such as personnel in the mine is designed around hand held PDA's with built in IEEE 802.11x wireless capabilities. The handheld will also have in most cases built-in GPS and Bluetooth capabilities. Utility vehicles used by maintenance, supervisory and engineering staff are based around industrial laptop/type units containing IEEE 802.11x wireless, GPS and Bluetooth capabilities. This allows the independent installation of the two devices, for example the GPS in the operator's helmet and the PDA in the operator's pocket without the need of wiring to join each other.

FIG. 4 shows a haul truck vehicle and a number of targets around it that axe communicating through the wireless link IEEE 802.11x. This capability opens up a number of possibilities to improve safety. This implementation of a two way communication system, is an enabling technology that allows safety interlock procedures to be implemented before moving a truck when other objects are in its zone. For example the driver can issue a request to start and a target in the area can deny this authorisation if a collision risk exists.

In a more sophisticated version of the proximity detection system described above, the velocity of both the haul truck vehicle and the surrounding mobile devices is taken into account. Although this system requires GPS to provide position fixes and velocity vectors, it only requires a standard GPS solution. The standard GPS solution only requires three satellites in view to operate and this is available in most open pit mines.

Each agent is equipped with GPS and broadcasts its position and velocity. The haul truck proximity system can then generate a different type of alarm according to the threat level, e.g. truck approaching in front, vehicle behind etc.

Although the system has capabilities to detect all these situations, the operator reporting capabilities will be very demanding in the situation shown in FIG. 7 where the truck 13 is moving forward as indicated by vector 14 and one or more “intruders” 15 are coming at the front of the truck.

In this situation, a high level alarm can be generated to warn the truck operator of the immediate impending danger.

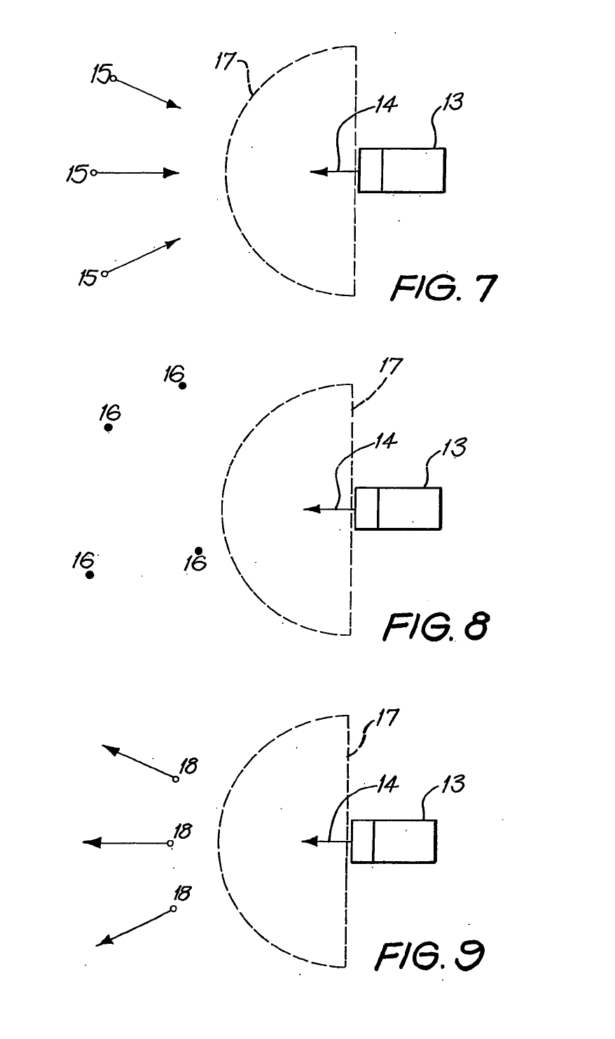

In other situations alarms may be generated at different levels. For example in the situation shown in FIG. 8 where the truck 13 is moving forward as shown by vector 14 but the intruders 16 are not moving, the alarm may not be triggered until the intruders enter the warning area defined by dotted line 17. A similar situation could apply as shown in FIG. 9 where the truck is moving forward as before but the intruders 18 are at the front of the truck and moving in the same direction.

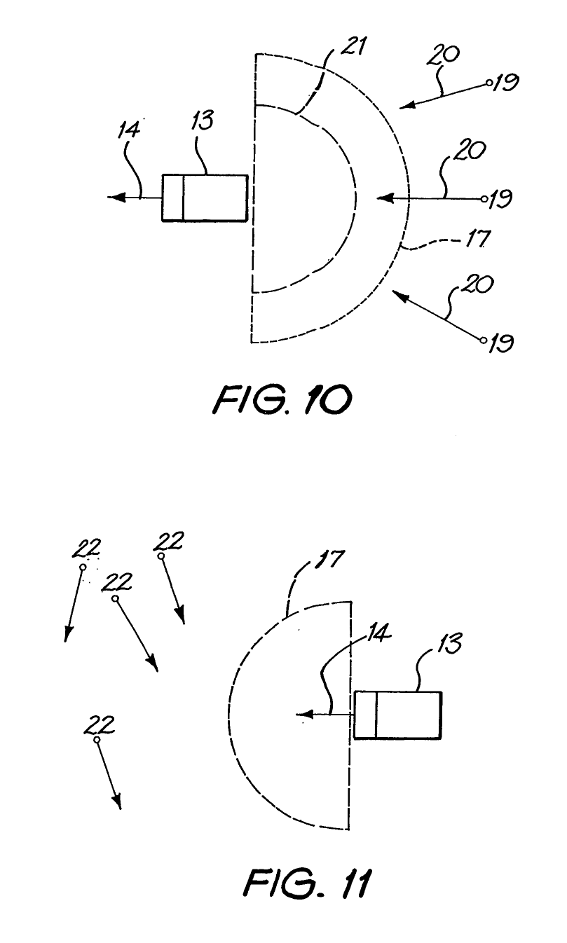

FIG. 10 shows yet another variation where the truck is moving forward but intruders 19 are approaching the truck from behind at velocities 20 greater than the velocity 14 of the truck 13. In situations like this, it may be desirable to have a separate danger area 21 defined inside the warning area 17 to alert the operator of the truck at different levels of danger as the intruder moves from the warning area into the danger area 21.

A further situation is shown in FIG. 11 where the intruders 22 may be at the front of the truck moving in a perpendicular direction. Again, the degree of warning provided to the truck operator may be tailored to the individual situation so that different levels of light and sound warnings can be provided to suit the degree of danger and the immediacy of the problem facing the truck operator.

In this manner a mine wide virtual wireless system is provided consisting of wireless nodes or stations (CPU, wireless capabilities, network capabilities, GPS, etc., mounted on mobile equipment and fixed base stations) linked together in a decentralized network. The system implements a flexible network backbone using mobile vehicles (such a trucks) that follow regular paths between load and dump locations. Other mobile and fixed nodes will interface with this data highway (transporting data to and from the central server) and can receive, transport and transmitted data collected from nodes that are more remote from the data highway. This system also provides the capability for personnel (supervisors, engineers, etc) operating in the mine to access systems on-board mobile equipment without the need to climb on-board. This capability to download data in the field from on-board systems in order to monitor productivity/reliability, etc., or upload new machine and operator tasks or settings, has the potential to change the way mines manage mobile equipment.

1-12. (canceled)

13. A virtual wireless computer network including a plurality of stations arranged to interface with each other by wireless communication in two or more regions, at least one of said regions being beyond normal wireless communication range of other said regions, and wherein at least one station is a mobile station able to travel between regions, said mobile station being adapted to receive and/or transmit information by wireless communication in one region when in that region, and receive and/or transmit information to other regions when in those regions.

14. A virtual wireless computer network as claimed in claim 13, wherein one or more of the mobile stations is located in a vehicle.

15. A virtual wireless computer network as claimed in claim 13, wherein one or more of the mobile stations is located on a person able to travel between regions.

16. A virtual wireless computer network as claimed in claim 13, wherein at least one of the stations is hard wire connected to a backbone system.

17. A virtual wireless computer network as claimed in claim 13, wherein the stations include slow moving stations primarily adapted to be operating within regions, and fast moving stations primarily intended to be moving between regions.

18. A virtual wireless computer network as claimed in claim 13, wherein the network is also adapted to be used as a safety alert system providing advice to the operator of a station of the presence of other stations that may be in the immediate proximity.

19. A virtual wireless computer network as claimed in claim 18, wherein the velocities of each of the stations are taken into account and a warning given to the operator appropriate to the danger detected.

20. A virtual wireless computer network as claimed in claim 19, when provided to the operator of an oversize off-road haul truck and wherein both the velocity of the haul truck, and the position and velocity of any potential intruders in the vicinity of the haul truck are taken into consideration.

21. A method of communicating information comprising the steps of providing a virtual wireless network as claimed in claim 13, and using that network to transfer information between regions.

22. A method as claimed in claim 21 when used in a mining environment.
